(19) United States
(12) Patent Application Publication
(10) Pub. No.: US 2003/0051569 A1
(43) Pub. Date: Mar. 20, 2003

(54) Screw actuator

(76) Inventors: Hendrikus Jan Kapaan, Nieuwegein (NL); Jerome Dubus, La Motte Servolex (FR)

Correspondence Address: Oliff & Berridge, PO Box 19928, Alexandria, VA, 22320, US

(21) Appl. No.: 10/220,319

(22) PCT Filed: Mar. 5, 2001
(86) PCT No.: PCT/NL01/00176

(30) Foreign Application Priority Data
Mar. 3, 2000 (NL) 1014561

(51) Int. Cl. F16H 25/22

(52) U.S. Cl. 74/424.85; 74/424.82; 74/89.23

(57) ABSTRACT

Screw actuator (1, 71), in particular brake actuator, comprising a hollow screw (14, 45, 51, 63, 74) which is driven in rotation and a nut (10, 72) which can thereby be displaced in the axial direction and in the case of a brake actuator acts as a piston (19). Rotary elements (23) are accommodated in the grooves delimited between screw and nut. There are means for recirculating these rotary elements. These means comprise a recess (47, 52, 58, 64) in the screw. This recess decreases in size in the direction towards the center axis of the grooves. This recess may comprise a wall aperture between two adjacent screws. It is also possible to arrange a tube which connects two recesses of this type. A further option consists in fitting an insert part in a recess in the screw.

The present invention relates to a screw actuator comprising a hollow screw which is driven in rotation and a nut which is arranged so that it can be displaced in translation, both the screw and the nut being provided with interacting helical grooves for accommodating rotary elements in the space which is thereby formed, the screw being provided with means for displacing the said rotary elements out of one part of the groove into another part of the groove in order to circulate the said rotary elements, said means comprising a recess which is arranged in the said screw.

A screw actuator of this type is known from Dutch patent 1009584, in the name of SKF Industrial Trading & Development Company B.V. This patent describes its use for a brake actuator. It should be understood that the present invention can also be used for brake actuators of this type but is not limited to this particular application. Other examples which may be mentioned include clutches, continuously variable transmissions, gear boxes and the like,

The particular feature that the nut of the screw actuator, unlike constructions which have been shown in the prior art, does not rotate but rather moves exclusively in translation while the screw is rotating, is essential to the present invention.

The fact that actuators of this type are used on an industrial scale means that the number of components in these actuators should be limited as far as possible. In this way, the costs of producing the components are reduced, the assembly costs are limited and the overall cost price can be lowered. Moreover, in general an actuator with fewer components will be more reliable.

The object of the present invention is to provide a screw actuator which reduces the number of components.

In a screw actuator as described above, this object is achieved in that the cross section of the said recess decreases from the outer side of the screw towards the centre axis of the said screw.

In the Dutch patent 1009584 referred to above, the rotary elements, in this case balls, are returned by a construction arranged on the outside of the screw. A construction of this type is complicated and undesirable. In subsequently filed patent applications/patents in the name of SKF Industrial Trading & Development Company B.V., which have not yet been published at the filing date of the present application, rercirculation through the interior of the screw is described. To that end insert elements are provided which are held in place with the aid of a sleeve positioned inside the screw, since otherwise they would drop out of the screw, with all the associated consequences.

With the aid of the construction according to the invention, it is possible to eliminate a sleeve of this type.

The invention can be implemented in a number of ways. A specific method can be selected as a function of the way in which the screw in question is manufactured. For example, the possible options for providing the screw with a specific shape differ if the screw is forged, cast or produced by powder metallurgy. Any further treatments are likewise dependent on the technique employed.

Moreover, the intended use is important. In corrosive environments, a corrosion-resistant coating may be applied to one or more of the components of the actuator. If the parts are exposed to wear, a wear-resistant surface coating which imparts hardness, such as a DLC coating, may be applied.

According to an advantageous embodiment of the invention, the rotary elements can be recirculated by removing that part of the wall which lies between two grooves of the screw. In this way, the rotary elements can enter a different part of the screw and form the desired path for endless recirculation. With a construction of this type, it is no longer necessary to form a continuous opening through the wall of the hollow screw.

According to a further variant of the invention, there is a tubular member connected to a recess which passes through the wall of the hollow screw. This tubular member preferably opens out at a further, corresponding continuous recess in the wall of the screw. This latter recess will generally lie upstream of the first recess. In this case, it is possible for this further recess to be arranged a number of turns upstream of the first recess. It is also possible for it to be positioned only one turn or part of a turn upstream. In the latter cases, it may be desirable to connect more than one tubular member to a number of sets of recesss. The result is a recirculation system with a number of separate annular tacks for the rotary elements.

Obviously, instead of a tubular member it is also possible to provide a bore using suitable shaping techniques, for example when using powder metallurgy it is possible to produce very complicated passages. This means that the screw may be of hollow or solid design.

In another design variant of the invention, the recess is provided with an insert part which is formed for the purpose of recirculation. In this case, the recess and the insert part are provided with interacting means in order to fix the position of this insert part in such a manner that it cannot be displaced. In any case, it must be impossible for the insert part to move through the recess towards the centre axis of the hollow screw. These means for fixing the insert part and the groove with respect to one another may be arranged in the recess, as described above, but it is also possible for the insert part to be provided with wings or the like which extend in the groove. In this case, the groove will be provided at that location with a recess or the like which adjoins and forms part of the recess.

The insert parts may be made from any desired material, such as metallic, nonmetallic and plastics materials. The insert part can be produced using any technique which is known in the prior art, for example powder metallurgy, sintering, casting and the like. The insert parts may optionally be formed directly or may be subjected to a further treatment, if appropriate after hardening.

The compressive force which is generated by the screw has to be absorbed by an axial thrust bearing, as is known in the prior art. Examples of such bearings include ball bearings or roller bearings.

According to a further embodiment of the invention, this is a fiber screw actuator. The two actuators may have an identical or different pitch with an identical or opposite pitch direction. If this screw actuator has an opposite pitch from that of the abovementioned actuator, it is possible to achieve an increased level of displacement at a reduced rotational speed of the screw with respect to the nut. Obviously, it is also possible to provide the screw actuator with various helical tracks, which extend substantially parallel to one another, for rotary elements, i.e. it is possible for there to be more than one start.

The inventive idea described above may be of single or multiple design, meaning that it is possible for there to be a number of screw tracks which extend parallel to one another and are each provided with insert parts or other means as described above for recirculation of balls or other rotary elements.

The screw can be driven in any manner which is known in the prior art, by means of keyways, ball races and the like. The drive means may be secured using any construction which is known in the prior art.

The measures described above relating to the axial pressure-absorbing bearing may, of course, be used in any screw actuator which may have any modulation means which is known in the prior art.

A few applications of a screw actuator of this type have been described above. It will be understood that the screw actuator can be adapted according to its use. It is also possible for more than one screw actuator to be used in a specific application. For example, in a brake calliper it is possible to use a number of actuators, for example a number which corresponds to the number of piston-cylinder assemblies in conventional brake callipers. Moreover, the screw actuator according to the invention can be used for both the operating brake and the parking brake of a vehicle.

The invention will be explained in more detail below with reference to exemplary embodiments which are illustrated in the drawing, in which:

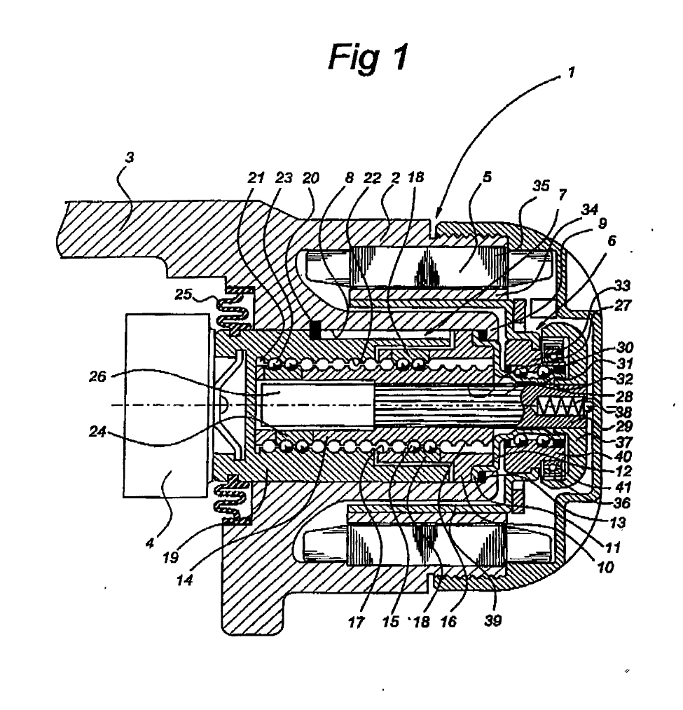

FIG. 1 shows a diagrammatic cross section through a brake actuator according to unpublished prior art;

FIG. 2 diagrammatically depicts a first embodiment of a screw according to the invention;

FIG. 3 diagrammatically depicts a cross section through a further variant of the invention;

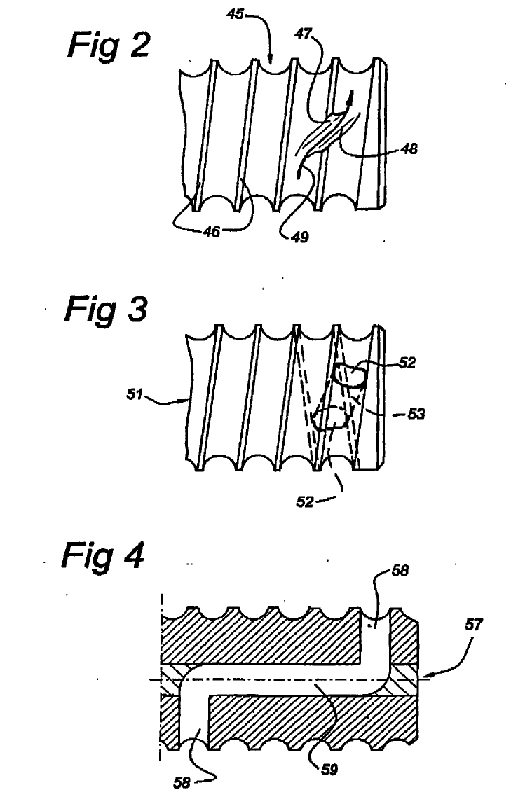

FIG. 4 diagrammatically depicts a cross section through a further variant of the invention;

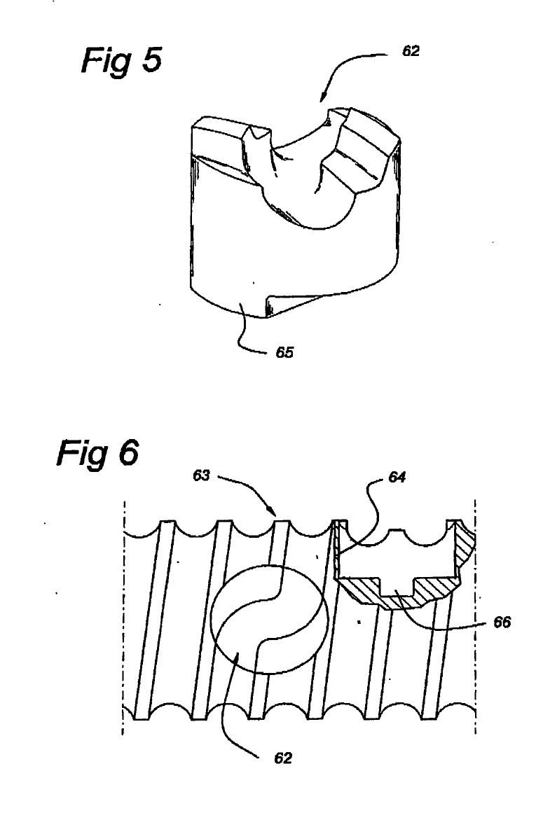

FIG. 5 shows an insert part;

FIG. 6 shows the use of the insert part from FIG. 5 in a diagrammatically depicted screw;

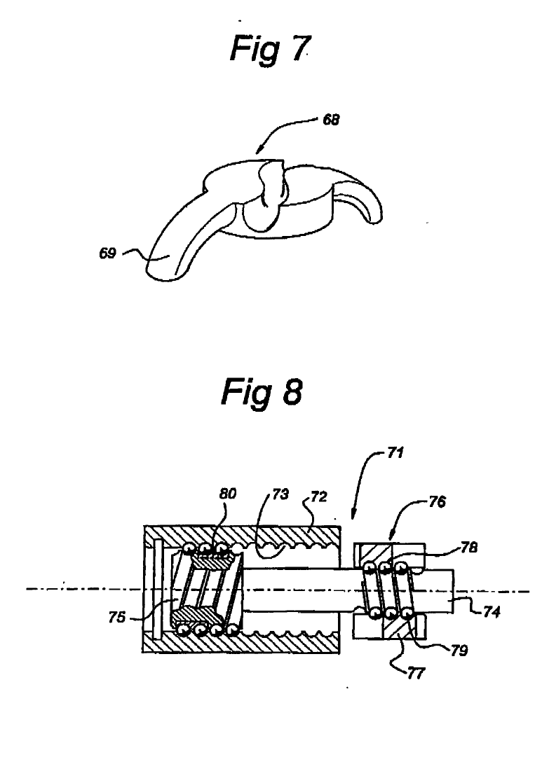

FIG. 7 diagrammatically depicts a further insert part; and

FIG. 8 diagrammatically depicts a cross section through an actuator according to a further embodiment of the invention.

The actuator 1 illustrated in FIG. 1 comprises a housing 2 which is attached to a calliper piece 3, part of which is illustrated. This calliper piece 3 bears two brake pads, of which one brake pad 4 is shown. The brake pads enclose a gap for accommodating a brake disc (not shown) of the related disc brake.

The housing 2 bears a motor 5 which drives the screw mechanism 7 by means of the reduction gear means 6.

This screw mechanism 7 is accommodated in a continuous bore 8 in the housing 2, which bore, at its end which is remote from the brake pad 4, has an inwardly extending flange 9.

The nut 10 of the screw mechanism 7 is fixed in the bore 8 in such a manner that it cannot move in translation and rotate. The nut 10 rests against the outwardly projecting flange 11 of the sleeve 12, which in turn rests, by means of a load cell 13, against a flange 9.

The screw mechanism 7 also includes a screw 14 and balls 15 which interact with the screw threads 17, 16 of the nut 10 and the screw 4, respectively.

The balls 15 are recirculated in the nut 10 by means of the recirculation insert pieces 18.

Furthermore, an actuator member 19 of the piston type is accommodated in the bore 8. This actuator member 19 can move in the axial direction but can never be rotated on account of the key/groove connection 20.

The actuator member also has an internal bore 21, provided with an internal screw thread 22.

The screw 14 extends in the bore 21 of the actuator member 19 and, by means of balls 23, interacts with the internal screw thread 22 of the actuator member 19. The balls 23 can be recirculated in the screw by means of the recirculation insert pieces 24.

The actuator member 19 of the piston type is protected from dirt by means of the bellows 25.

The screw has an internal sleeve 26 which holds the recirculation insert pieces 24 in place. Furthermore, a lubricant-metering member may be incorporated in this sleeve 26.

Furthermore, the screw 14 has an internal bore 27 which interacts slideably with the drive shaft 29 by means of a groove/key connection 28. When the drive shaft 29 is rotated, the screw 14 also turns and is displaced in linear fashion with respect to the nut 10 and also with respect to the drive shaft 29. The actuator member 19 of the piston type is also displaced in linear fashion with respect to the screw 14, resulting in a relatively great linear displacement.

The screw thread 16 of the screw 14 and the screw thread 22 of the actuator member 19 also act as a support bearing for the actuator member 19.

In view of the fact that a relatively great displacement is obtained by the double or tandem actuator action, a reduction gear 6 with a relatively great reduction ratio is required.

This reduction gear 6 comprises a support 30 provided with a bearing 31, the inner race 32 of which forms a unit with the sleeve 12. The outer race 33 of the bearing 31 is connected to the rotor 34 of the motor 5. The stator 35 is connected to the housing 2.

The outer ring 33 of the bearing 31 also has an eccentric hub which bears an eccentric bearing 41 which supports the eccentric gear wheel 36 which engages in a section of the inwardly facing teeth of the gear wheel 37.

As a result of the eccentric gear wheel 36 being rotated by the rotor 34, the gear wheel 37 is moved with a relatively great reduction ratio.

The outer circumference of the outer race 33 has a diameter which slightly smaller than the opening defined by the inwardly extending flange 9 of the bore 8. In this way, the entire assembly of the screw mechanism 7 and the reduction gear 6 can be pushed through the bore 8 into the position illustrated in the figure. The rotor 34 can then be fitted, and finally the drive shaft 28 together with the gear wheel 37 is fitted.

A resilient support 31 is provided for the purpose of keeping the drive shaft 29 in position.

In the structure shown in FIG. 1, it is necessary for sleeve 26 to be present, since this is what prevents the insert part 24, which is responsible for recirculation, from dropping inwards.

In order to avoid the drawback of an additional component, with all the associated consequences, the invention makes a number of proposals.

A first embodiment of the invention is illustrated in FIG. 2. This figure only shows a screw 45. The associated nut structure can be designed in any way which is known in the prior art, and as an example reference is made to FIG. 1 which has been described above. Screw 45 comprises a single helical groove and wall 46 between adjacent grooves is locally provided with an aperture or recess 47. This recess extends as far as the “base 48” of the hollow screw 45. The path of the rotary elements is indicated by 49. In this way, it is possible to obtain a recirculation system.

FIG. 3 shows a further variant of the invention. The screw is denoted overall by 51 and comprises two continuous recesss 52 which lie obliquely opposite one another. They are connected by a hollow tube 33, so that the rotary elements can pass through the hollow tube, via the relevant recess, back to the previous turn of the groove. With the construction shown in FIG. 3. it is possible to arrange a number of these recesss, in each case together with a hollow tube.

FIG. 4 shows a further variant. In this figure, the screw is denoted overall by 57. The recesses are indicated by 58, while the tube is indicated by 59. It can be seen from this figure that the length of the tube is such that the rotary elements are transported a number of turns back, so that a recirculation system is formed.

According to a further variant of the present invention, an insert part can be positioned in the recess. An example of an insert part of this type is shown in FIG. 5 and is denoted by 62. As well as a specially shaped surface in order to effect recirculation, it is provided with a projection 65 which can be accommodated in a receiving recess 66 in recess 64 of screw 63. This is shown in FIG. 6. It will be understood that the projection/receiving recess arrangement can be reversed and that the insert part can be fixed in other ways with respect to the screw 63.

An example of an embodiment of this type is shown in FIG. 7, which only illustrates an insert part 68. It is clear that this insert part is provided with wings 69 which are shaped in such a manner that they can be accommodated in the groove part which adjoins the recess in the screw (not shown). In this case, the groove adjacent to the recess may be provided with a recess, but this is not absolutely necessary.

FIG. 8 shows a further use of the invention. The actuator shown in that figure is denoted overall by 71. The “nut” is denoted by 72 and the groove in which the balls or other rotary elements run is denoted by 73. The screw is indicated by 74 and is likewise provided with a groove denoted by 75. The left-hand part of FIG. 8 which has just been discussed corresponds to the constructions described above. However, the axial thrust bearing used in this case, which is denoted overall by 70, has a particular design. According to this variant embodiment, it is designed as a further actuator which, however, has an opposite pitch. The left-hand part of FIG. 8 is provided with a left-hand pitch, while the right-hand part is provided with a right-hand pitch. This left-hand part is provided with insert part 80. The nut of the further actuator is denoted by 77 and is provided with a groove 78 which interacts with a groove 79 which between them delimit a receiving recess for rotary elements. With this construction, it is possible, with relatively limited displacement of screw 74 and an acceptable pitch of the screw and/or nut, nevertheless to obtain considerable displacement of nut 72.

It will be understood that the construction described with reference to FIG. 8 can be used independently of the recirculation system described above. This means that any other recirculation system may be present therein, although according to the invention it is preferred to use the recirculation system which has been described above with reference to a number of examples.

After studying the large number of variants described above, further embodiments which are obvious and lie within the scope of the appended claims will be immediately apparent to the person skilled in the art.

1. Screw actuator (1, 71) comprising a screw (14, 45, 51, 57, 63, 74) which is driven in rotation and a nut (10, 72) which is arranged so that it can be displaced in translation, both the screw and the nut being provided with interacting helical grooves for accommodating rotary elements in the space which is thereby formed, the screw being provided with means for displacing the said rotary elements out of one pant of the groove into another part of the groove in order to circulate the said rotary elements, said means comprising a recess (47, 52, 58, 64) which is arranged in the said screw, characterized in that the cross section of the said recess decreases from the outer side of the screw towards the longitudinal axis of the said screw.

2. Screw actuator according to claim 1, in which the said recess comprises a broken wall section (46) between two adjacent grooves.

3. Screw actuator according to claim 2, in which the said recess is provided with a base (48) which encompasses the screw.

4. Screw actuator according to one of the preceding claims, in which the said means comprise a tubular member (53, 59), which is connected to the recess, for guiding the said rotary elements.

5. Screw actuator according to claim 4, in which the said tubular member at the other end opens out into a further recess.

6. Screw actuator according to claim 4 or 5, comprising a number of tubular members.

7. Screw actuator according to one of the preceding claims, in which the said means comprise an insert part (68) provided with position-determining parts (65) which interact with corresponding position-determining parts (66) in the said recess.

8. Screw actuator according to one of the preceding claims, in which the said means comprise an insert part (68) which is provided with position-determining parts which interact with corresponding position-determining parts in the said grooves.

9. Screw actuator according to claim 7 or 8, in which the said insert part comprises a lubricant.

10. Screw actuator according to one of claims 7-9; in which the said insert part has a DLC coating.

11. Screw actuator according to one of the preceding claims, in which the said screw is provided with a bearing which absorbs axial pressure, which pressure-absorbing bearing comprises a further screw actuator (71).

12. Screw actuator according to claim 11, in which the said further screw actuator has an opposite pitch to that of the first actuator.

13. Screw actuator according to one of the preceding claims, comprising at least two recirculation grooves, each provided with at least one recess and associated means for displacing rotary elements according to one of the preceding claims.

14. Screw actuator according to one of the preceding claims, in which the said screw is a hollow screw.

15. Screw actuator according to one of claims 1-13, in which the said screw is a solid screw.

16. Screw actuator according to one of the preceding claims, comprising a brake actuator.

17. Screw actuator according to one of claims 1-15, comprising a clutch actuator.

18. Screw actuator according to one of claims 1-15, comprising a shift actuator for a gear box.

19. Screw actuator according to one of claims 1-15, comprising a steering actuator for steerable wheels.
